(19) United States
(12) Patent Application Publication
(10) Pub. No.: US 2007/0097308 A1
(43) Pub. Date: May 3, 2007

(54) THIN FILM TRANSISTOR ARRAY SUBSTRATE AND LIQUID CRYSTAL DISPLAY

(76) Inventors: Wen-Hsiung Liu, Pingtung County (TW); Hui-Chung Shen, Taipei County (TW); Megn-Feng Hung, Changhua County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,811

(22) Filed: Oct. 31, 2005

(51) Int. Cl. G02F 1/1345

(52) U.S. Cl. 349/149

(57) ABSTRACT

A thin film transistor array substrate comprises a substrate, a plurality of scan lines and data lines, a plurality of pixel units, a plurality of scan bonding pads and data bonding pads, and a plurality of first and second switching devices. On the substrate are disposed the scan lines and data lines, which divide the display region into a plurality of pixel areas. The scan bonding pads are electrically connected to the scan lines. The data bonding pads are electrically connected to the data lines. The first and the second switching elements are disposed in the peripheral circuit region, wherein at least one of the first switching elements is disposed between two adjacent scan bonding pads and is electrically connected thereto. At least one of the second switching elements is disposed between two adjacent data bonding pads, and is electrically connected thereto.

### BACKGROUND OF THE INVENTION

1. Field of the Invention

The present invention generally relates to a device array substrate and display panel, and more particularly, relates to a thin film transistor (TFT) array substrate and a liquid crystal display (LCD) panel with an anti-static capability.

2. Description of Related Art

With the rapid advancement of electro-optical technology and semiconductor fabricating technology in recent years, flat display panels accordingly developed at a fast speed. Among flat display panels, a type of thin film transistor liquid crystal display (TFT-LCD) has become main stream due to its advantages including low-voltage operation, fast operating speed, light weight and less space requirements.

A thin film transistor LCD mainly comprises an LCD panel and a backlight module, wherein the LCD panel is comprised of a color filter (C/F), a thin film transistor array substrate (TFT array substrate) and a liquid crystal layer disposed between the filter and the substrate. The backlight module serves to provide a plane light source required for the LCD panel to display images.

FIG. 1 shows a conventional TFT array substrate 100 which comprises a substrate 110, a plurality of scan lines 120, a plurality of data lines 130, a plurality of pixel units 150, a plurality of scan bonding pads 160, a plurality of data bonding pads 170, a plurality of inner anti-static guard rings 192, and a plurality of external anti-static guard rings 194.

The substrate 110 has a display region 112 and a peripheral circuit region 114. The scan lines 120 and data lines 130 are disposed on the substrate 110, wherein the scan lines 120 and data lines 130 divide the display region 112 into a plurality of pixel areas 140. The pixel units 150 are respectively disposed inside one of the pixel areas 140 and driven by the scan lines 120 and data lines 130. The pixel unit 150 is comprised of a TFT 152 and a pixel electrode 154.

In FIG. 1, the scan bonding pads 160 are disposed in the peripheral circuit region 114 and electrically connected to the scan lines 120. The data bonding pads 170 are disposed in the peripheral circuit region 114 and electrically connected to the data lines 130. The inner anti-static guard rings 192 are disposed in the peripheral circuit region 114 and between the scan bonding pads 160 and the display region 112 and between the data bonding pads 170 and the display region 112 as well. Additionally, the inner anti-static guard rings 192 are electrically connected to the scan lines 120 and data lines 130, and are anti-static guard circuits comprised of active switch elements (for example, a TFT or diode) and the scan lines 120, and data lines 130 that surround the active switch elements. Moreover, the external anti-static guard rings 194 are disposed in the peripheral circuit regions 114 and are located between the scan bonding pads 160 and the outside of the substrate 110, between the data bonding pads 170 and the outside of the substrate 110. Likewise, the external anti-static guard rings 194 are electrically connected to the scan lines 120 and data lines 130, and are anti-static guard circuits comprised of the active switch elements (for example, an TFT or diode), the scan lines 120 and data lines 130 that surround the active switch elements.

The TFT substrate 100 tends to accumulate static charge because of external factors, such as transporting or environment changes, during the fabrication of the TFT substrate. Thus, when static charges are accumulated to a certain extent, the circuits and the TFT 152 disposed on the TFT substrate 100 may suffer damage due to the static discharge. Therefore, the inner anti-static guard rings 192 and the external anti-static guard rings 194 are used to prevent the static discharge from leaking into the whole TFT substrate 100 so as to prevent the locally-accumulated static discharges from damaging the circuits or the pixel units 150 in the display region 112.

In detail, the inner anti-static guard rings 192 or the external anti-static guard rings 194 are a structure that is connected to the scan lines 120 and data lines 130 through the active switch element (not shown). Accordingly, when the static charges on the scan lines 120, data lines 130 or TFT 152 are overloaded, the active switch element can be switched on to dissipate the static charge into the inner anti-static guard rings 192 and/or the external anti-static guard rings 194 to execute to the anti-static function.

However, with the design of the inner anti-static guard rings and the external anti-static guard rings 194, damage caused by the static charge can still occur, especially in the area of the scan bonding pads 160 and the data bonding pads 170 due to their large area and the easy accumulation of the static charge. Hence, when the static charge can not be dissipated, the damage caused by the static charge still occurs to the circuits and the TFT 152 disposed on the TFT substrate 100.

### SUMMARY OF THE INVENTION

Accordingly, the present invention is directed to provide a TFT substrate suitable for dissipating the large amount of the static charge accumulated on the TFT substrate, thereby further reducing damage caused by the static discharge.

Accordingly, the present invention is directed to an LCD panel that utilizes the preceding TFT substrate so as to enable the LCD panel to have an anti-static guard capability.

Based on the above objective or other objectives, the present invention provides a TFT array substrate which comprises a substrate, a plurality of scan lines and data lines, a plurality of pixel units, a plurality of scan bonding pads and data bonding pads, and a plurality of first and second switching devices. The substrate comprises a display region and a peripheral circuit region. On the substrate are disposed the scan lines and data lines which divide the display region into a plurality of pixel areas. The pixel units are respectively disposed in one of the pixel areas and are driven by the scan lines and the data lines. The scan bonding pads are disposed in the peripheral circuit region and electrically connected to the scan lines. The data bonding pads are disposed in the peripheral circuit region and electrically connected to the data lines. The first switching element is disposed in the peripheral circuit region. At least one of the first switching elements is disposed between two adjacent scan bonding pads and is electrically connected thereto. The second switching element is disposed in the peripheral circuit region. At least one of the second switching elements is disposed between two adjacent data bonding pads, and is electrically connected thereto.

In one embodiment of the present invention, between two adjacent scan bonding pads are disposed two first switching elements that are connected in parallel.

In one embodiment of the present invention, between two adjacent scan bonding pads are disposed two second switching elements that are connected in parallel.

In one embodiment of the present invention, each of the aforesaid first switching element comprises a floating gate, a gate insulating layer, a semiconductor layer, and the source and the drain. The floating gate is disposed on the substrate and is covered by the gate insulating layer. The semiconductor layer is disposed on the gate insulating layer over the floating gate. The source and the drain are disposed on the semiconductor layer, wherein the source and the drain are electrically connected to the scan bonding pads disposed at two sides thereof. Additionally, the source and the drain are asymmetrically or symmetrically disposed.

In one embodiment of the present invention, each of the aforesaid second switching elements comprises a floating gate, a gate insulating layer, a semiconductor layer, and the source and the drain. The floating gate is disposed on the substrate, and the gate insulating layer covers the floating gate. The semiconductor layer is disposed on the gate insulating layer over the floating gate. The source and the drain are disposed on the semiconductor layer, wherein the source and the drain are electrically connected to the data bonding pads located at the two sides thereof (of the source and the drain). Additionally, the source and the drain are asymmetrically or symmetrically disposed.

In one embodiment of the present invention, each of the aforesaid pixel units comprises a TFT and a pixel electrode. The TFT is disposed in one of the pixel areas. The pixel electrode is disposed in one of the pixel areas and electrically connected to the TFT.

In one embodiment of the present invention, the aforesaid TFT array substrate further comprises a plurality of inner guard rings which are disposed in the peripheral circuit region, located between the scan bonding pads and the display region and between the data bonding pads and the display region. The inner guard rings are electrically connected to the scan lines and data lines.

In one embodiment of the present invention, the aforesaid TFT array substrate further comprises a plurality of external guard rings which are disposed in the peripheral circuit region, located between the scan bonding pads and the outside of the substrate and between the data bonding pads and the outside of the substrate. The external guard rings are electrically connected to the scan lines and data lines.

To achieve these and other advantages and in accordance with the purpose of the invention, as embodied and broadly described herein, the present invention provides a liquid crystal display panel which comprises a color filter substrate, a TFT array substrate and a liquid crystal layer. The TFT array substrate can be, for example, the aforesaid TFT array substrate, and the liquid crystal layer is disposed between the color filter substrate and the TFT array substrate.

The present invention utilizes the first and second switching elements that are disposed respectively between two adjacent scan bonding pads and between two adjacent data bonding pads. When a large amount of the static charge is accumulated on the scan bonding pads or on the data bonding pads, due to the accumulated static charge, a charge coupled effect occurs on the first and second switching elements so that the first switching elements and the second switch elements are turned on.

Thus, the accumulated static charge transports between the adjacent scan bonding pads or the adjacent data bonding pads, thereby reducing the TFT array substrate's damages caused by the accumulated static charge.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows a conventional TFT array substrate.

FIG. 2 shows a TFT array substrate of one embodiment of the present invention.

FIG. 3 is an enlarged top view of the scan bonding pads disposed in A location as showed in FIG. 2.

FIG. 3A is a cross-sectional view along the A-A′ line of FIG. 3.

FIG. 3B is a cross-sectional view along the B-B′ line of FIG. 3.

FIG. 4 is an enlarged top view of the scan bonding pads disposed in B location as showed in FIG. 2.

FIG. 4A is a cross-sectional view along the C-C′ line of FIG. 4.

FIG. 4B is a cross-sectional view along the D-D′ line of FIG. 4.

FIG. 5 shows an LCD panel of one embodiment of the present invention.

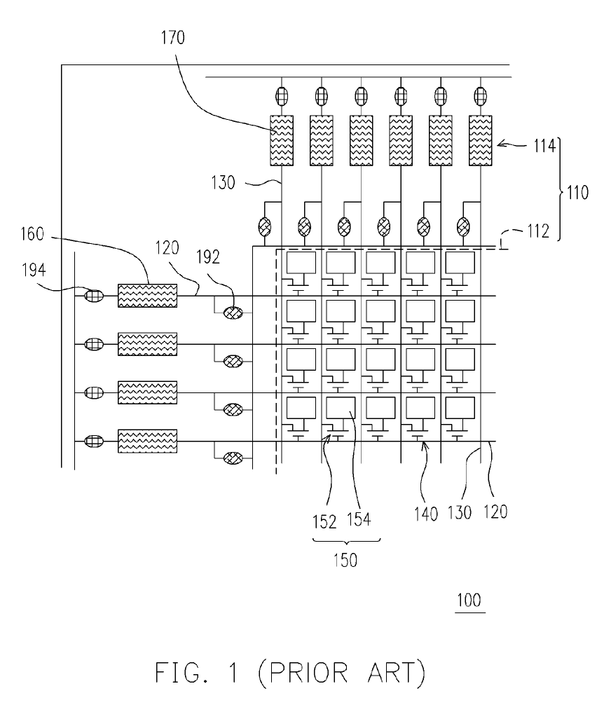

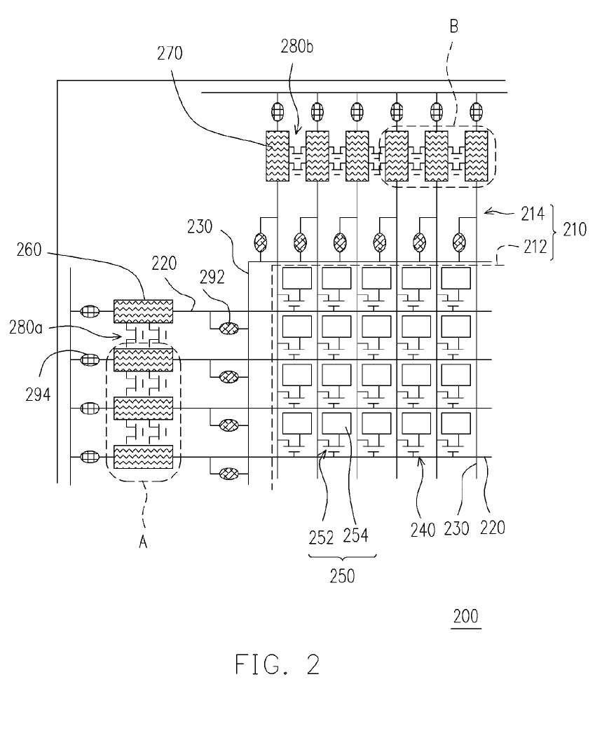

### DESCRIPTION OF THE EMBODIMENTS

Reference is now made in detail to the present invention, examples of which are illustrated in the accompanying drawings. Wherever possible, the same reference numbers are used in the drawings and description to refer to the same or like parts.

FIG. 2 shows a TFT array substrate of one embodiment of the present invention. The TFT array substrate 200 comprises a substrate 210, a plurality of scan lines 220 and data lines 230, a plurality of pixel units 250, a plurality of scan bonding pads 260 and data bonding pads 270, and a plurality of first switching elements 280a and second switching elements 280b.

The substrate 210 has a display region 212 and a peripheral circuit region 214. On the substrate 210 are disposed the scan lines 220 and data lines 230 which divide the display region 212 into a plurality of pixel areas 240. Each pixel unit 250 is respectively disposed in one of the pixel areas 240 and driven by the scan lines 220 and the data lines 230. The scan bonding pads 260 are disposed in the peripheral circuit region 214 and electrically connected to the scan lines 220. The data bonding pads 270 are disposed in the peripheral circuit region 214 and are electrically connected to the data lines 230. The first switching element 280a and the second switching element 280b are disposed in the peripheral circuit region 214. At least one of the first switching elements 280a (two first switching elements are shown in FIG. 2) is disposed between and electrically connected with two adjacent scan bonding pads 260. At least one of the second switching elements 280b (two second switching elements are shown in FIG. 2) is disposed between and electrically connected with two adjacent data bonding pads 270.

FIG. 2 is one embodiment of the present invention. Each of the aforesaid pixel units comprises a TFT 252 and a pixel electrode 254. The TFT 252 is disposed in one of the pixel areas 240. The pixel electrode 254 is disposed in one of the pixel areas 240 and electrically connected to the TFT 252.

Additionally, as shown in FIG. 2, the TFT array substrate 200 further comprises, for example, a plurality of inner guard rings 292 which are disposed in the peripheral circuit region 214, between the scan bonding pads 260 and the display region 214 and between the data bonding pads 270 and the display region 214. The inner guard rings 292 are electrically connected to the scan lines 220 and data lines 230. The TFT array substrate 200 further comprises, for example, a plurality of external guard rings 294 which are disposed in the peripheral circuit region 214, between the scan bonding pads 260 and the outside of the substrate 210 and between the data bonding pads 270 and the outside of the substrate 210. The external guard rings 294 are electrically connected to the scan lines 220 and data lines 230.

In detail, the inner anti-static guard rings 292 or the external anti-static guard rings 294 are structures that are connected to the scan lines 220 and data lines 230 through the active switch elements (not shown). Accordingly, when the static charge on the scan lines 220 and data lines 230 or on the TFT 252 is overloaded, the active switch element can be switched on to dissipate the static charge into the inner anti-static guard rings 292 and/or the external anti-static guard rings 294 in order to achieve the anti-static effect. However, a large amount of the static charge is still accumulated in the areas of the scan bonding pads 260 and data bonding pads 270. Thus, in the present invention, the first switching element 280a and the second switching element 280b are disposed respectively between two adjacent scan bonding pads 260 and between two adjacent data bonding pads 270. In one embodiment of the present invention, between two adjacent scan bonding pads 260 are disposed two first switching elements 280a that are connected in parallel. In one embodiment of the present invention, between two adjacent scan bonding pads 270 are disposed two second switching elements 280b that are connected in parallel so that the static can be discharged in two-way conduction.

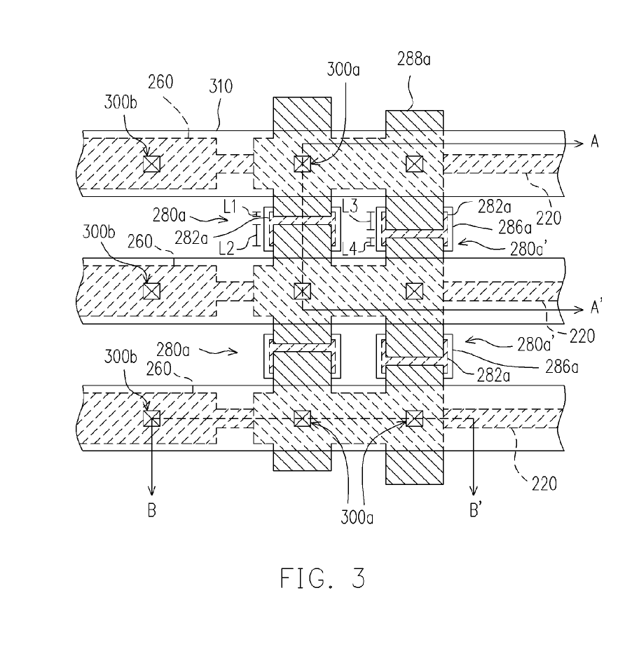

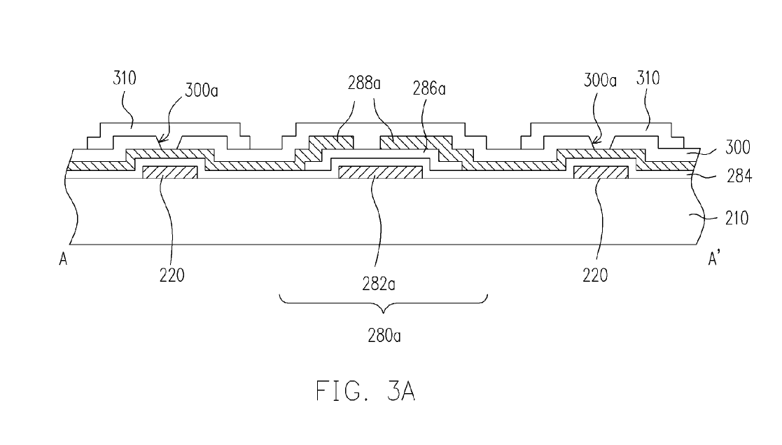

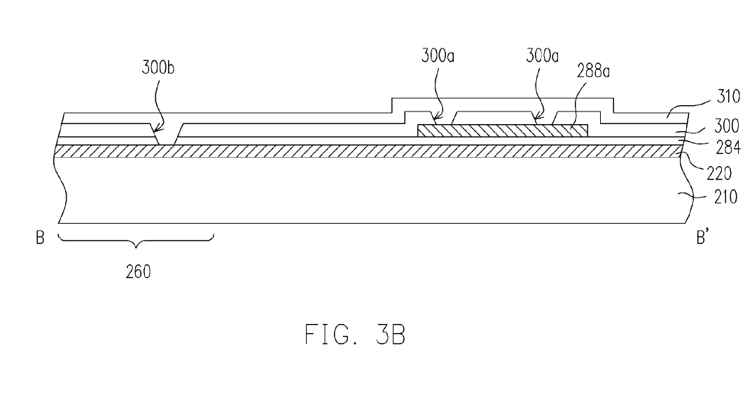

FIG. 3 is an enlarged top view of the scan bonding pads disposed in A location as shown in FIG. 2. FIG. 3A is a cross-sectional view along the A-A′ line of FIG. 3 and FIG. 3B is a cross-sectional view along the B-B′ line of FIG. 3.

In FIGS. 3 and 3A of one embodiment of the present invention, each first switching element 280a comprises a floating gate 282a, a gate insulating layer 284, a semiconductor layer 286a, the source and the drain 288a. The floating gate 282a is disposed on the substrate 210 and the gate insulating layer 284 covers the floating gate 282a. The semiconductor layer 286a is disposed on the gate insulating layer 284 over the floating gate 282a. The source and the drain 288a are disposed on the semiconductor layer 286a and are electrically connected to the scan bonding pads 260 located on both sides of the source and the drain.

In a conventional process of forming the pixel array, conductor lines (such as the scan lines and data lines), TFTs, and pixel electrodes are formed on the substrate 210. The conventional process of forming the pixel array can be a five-mask process, four-mask process or any known process of forming the pixel array. In FIGS. 3, 3A and 3B, the three figures show the five-mask process. In FIG. 3, the scan lines 220, the scan bonding pads 260 and the floating gate 282a of the first switching element 280a are formed simultaneously on the substrate 210 by using the first mask process (i.e. metal 1 mask). Subsequently, on the substrate 210 are entirely formed the gate insulating layer 284 to cover the scan lines 220, the scan bonding pads 260 and the floating gate 282a. Then, the semiconductor layer 286a is formed on the floating gate 282a by applying the second mask process. The source and the drain 288a are then formed by plating a metal layer in the third mask process (metal 2). Afterwards, on the substrate 210 is entirely formed a protection layer 300; then, the fourth mask process is used to define first openings 300a and second openings 300b. In other words, the first openings 300a for exposing the source and the drain 288a are formed on the protection layer 300 over the scan lines 220, and the second openings 300b for exposing the scan bonding pads 260 are formed in the protection layer 300 and the gate insulating layer 284 over the scan bonding pads 260. A conductor layer 310 (such as ITO) is then formed over the scan lines 220 and the scan bonding pads 260 by using the fifth mask. Please note that in FIGS. 3, 3A and 3B, the conductor layer 310 enables the source and the drain 288a and the scan bonding pads 260 to be electrically connected through the first openings 300a and second openings 300b.

In other words, in FIG. 3, when a large amount of the static charge is accumulated on one of the scan bonding pads 260, the static charge can be transmitted from the scan bonding pads 260 to the source and the drain 288a of the first switching elements 280a. Then, the charge coupling effect occurs between the source and the drain 288a and the floating gate 282a, thereby turning on the first switching elements 280a. Accordingly, the static charge accumulated on the scan bonding pads 260 can be transmitted to their adjacent scan lines 260 through the semiconductor layer 286a of the first switching elements 280a. Hence, the static charge can not be accumulated on the scan bonding pads 260, and the neighboring regions of the scan bonding pads 260 can be prevented from being damaged.

Additionally, please note that the source and the drain 288a of the first switching elements 280a can be asymmetrically or symmetrically disposed. In FIG. 3, one embodiment of the present invention, the source and the drain 288a of the first switching elements 280a are, for example, asymmetrically disposed so that in a limited space, the source and the drain 288a have a better static-charge-accumulating capability that enhances the charge coupling effect between the source and the drain 288a and the floating gate 282a. In detail, the length of the source (or the drain) of the first switching element 280a is L1 while the length of the drain (the source) is L2, wherein L2 is larger that L1. As L2 is longer, the drain with the length L2 has a larger space to accommodate the static charge so that the charge coupling effect occurs easily between the drain 288a and the floating gate 282a. As a result, when the static charge is accumulated, the first switching element 280a is more easily turned on, which allows the static charge to transmit from the drain with the length L2 to the source with the length L1.

In addition, when two first switching elements 280a and 280a′ are disposed between two adjacent scan bonding pads 260, the first switching elements 280a′ is preferably asymmetrically disposed, especially when the lengths of the source and the drain 288a disposed over the floating gate 282a of the first switching element 280a′ are contrary to those of the aforesaid case. In other words, the first switching element 280a′ in FIG. 3 has the source (or the drain) with a length L3, while the first switching element has the drain (or the source) with a length L4, wherein L3 is larger than L4. As a result, the static charge transmits from the drain with the length L3 to the source with the length L4. In brief, when two first switching elements 280a and 280a′, connected in parallel, are disposed between two adjacent scan bonding pads, and when the source and the drain 288a are asymmetrically disposed, in addition to the first switching elements (280a, 280a′)'s being quickly turned on, the transmitting of the static charge can be conducted two-way.

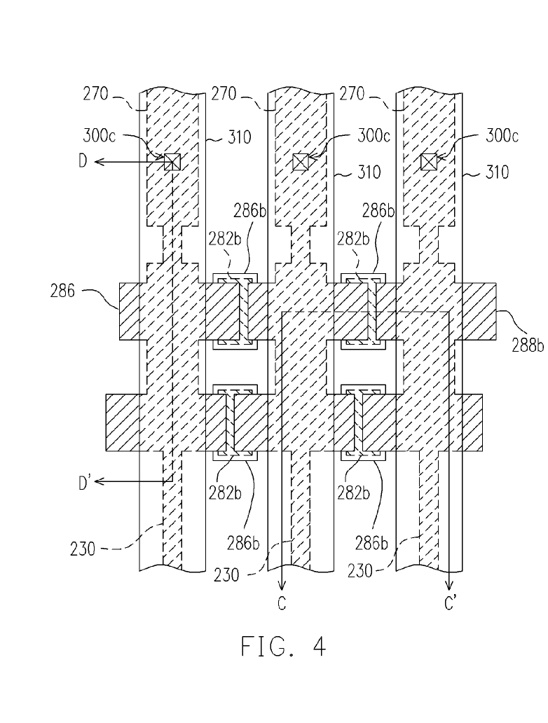

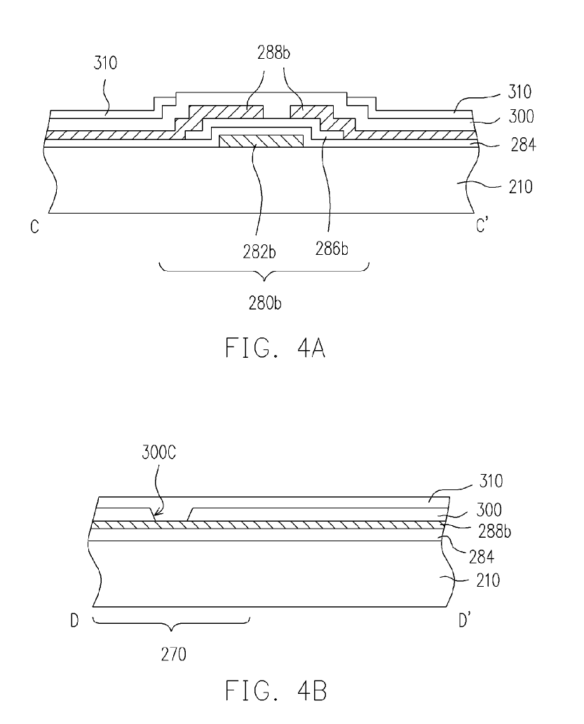

FIG. 4 is an enlarged top view of the scan bonding pads disposed in B location as shown in FIG. 2. FIG. 4A is a cross-sectional view along the C-C′ line of FIG. 4, and FIG. 4B is a cross-sectional view along the D-D′ line of FIG. 4.

In FIGS. 4 and 4A, one embodiment of the present invention, each of the second switching elements 280b comprises a floating gate 282b, a gate insulating layer 284, a semiconductor layer 286b, the source, and the drain 288b. The floating gate 282b is disposed on the substrate 210, and the gate insulating layer 284 covers the floating gate 282b. The semiconductor layer 286b is disposed on the gate insulating layer 284 over the floating gate 282b. The source and the drain 288b are disposed on the semiconductor layer and are electrically connected to the data bonding pads 270 disposed at the two sides thereof.

Similarly, a five-mask process, a four-mask process or any known process of forming the pixel array can be employed to fabricate the aforesaid elements. Take the five-mask process as an example. In FIGS. 4, 4A and 4B, the floating gate 282b of the second switching element 280b is formed on the substrate 210 by using the first mask process (i.e. metal 1 mask). Subsequently, on the substrate 210 are entirely formed the gate insulating layer 284 to cover the floating gate 282b. Then, the semiconductor layer 286b is formed over the floating gate 282b by using the second mask process. ?????The metal layer formed by the scan lines 230, the data bonding pads 270 and source and the drain 288a are then simultaneously formed by patterning a same metal layer with the third mask (metal 2). Afterwards, on the substrate 210 is entirely formed a protection layer 300, which is patterned through using the fourth mask to form third openings 300c for exposing the data bonding pads 270. A conductor layer 310 (such as ITO) is then formed over the data lines 230 and the data bonding pads 270 by using the fifth mask. It is noted that as shown in FIGS. 4, 4A and 4B, the source and the drain 288b and the data bonding pads 270 are formed with the same metal layer and thus are electrically connected each other.

In other words, as shown in FIG. 4, when there is accumulated a large amount of the static charge on one of the data bonding pads 270, the static charge is able to transport from the data bonding pads 270 to the source and the drain 288b of the second switching element 280b. As such, there occurs a charge coupled effect between the source and the drain 288b and the floating gate 282b, thereby turning on the second switching element 280b. Accordingly, the static charge accumulated on the data bonding pads 270 can be transported to their adjacent data lines 230 through the semiconductor layer 286b of the second switching element 280b. Hence, the static charge is not accumulated on the data bonding pads 270, preventing the neighborhood of the data bonding pads 270 from being damaged.

Additionally, likewise, the source and the drain 288b of the second switching element 280b can be asymmetrically or symmetrically disposed. The objective, way and effect of this asymmetrical or symmetrical disposition have been aforementioned so that their descriptions are omitted here. In brief, when two second switching elements 280b are disposed between two adjacent data bonding pads 270 and the source and the drain 288b are asymmetrically disposed, in addition to the second switching element (280b)'s quickly turning on, the transportation of the static charge may be conducted two ways.

In summary, the dispositions of the first and second switching elements are accomplished by using the five-mask process so that there is no need of any extra process. Besides, as the first and second switching elements are respectively disposed between two adjacent scan bonding pads and between adjacent data bonding pads, the static charge triggers the charge coupling effect of the first switching elements and/or the second switching elements, thereby turning on the first switching elements and/or the second switching elements. As such, the static charge has less likelihood of being locally accumulated on the scan bonding pads and the data bonding pads, thereby lowering damage caused by the static charge. In addition, the LCD panel implements the preceding TFT array substrate to form the LCD panel with a better anti-static guard capability.

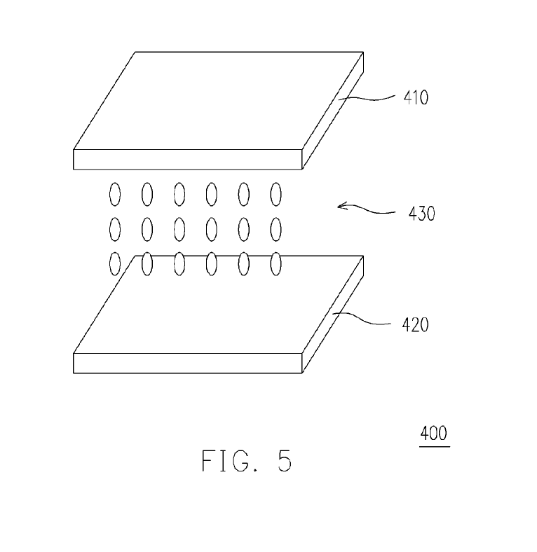

FIG. 5 shows an LCD panel of a preferred embodiment of the present invention. The LCD panel 400 comprises a color filter substrate 410, a TFT substrate 420 and a liquid crystal layer 430. The TFT substrate 420 may be, for example, the TFT substrate 200 as shown in FIG. 2. The liquid crystal layer 430 is disposed between the color filter substrate 410 and the TFT substrate 420.

On the color filter substrate 410 are disposed a common electrode (not shown) and a color filter array (not shown). There occurs an electrical field between the common electrode and the pixel electrode (not shown) of the TFT array substrate 420 so as to rotate liquid crystal molecules disposed between the color filter substrate 410 and the TFT array substrate 420, which in turn varies the intensity of incident light. In addition, the color filter substrate 410 makes the LCD panel 400 fully colorized. Since the present invention employs the TFT array substrate 200 as shown in FIG. 2, the LCD panel 400 of the present invention has a better anti-static guard capability.

In summary, the TFT array substrate and the LCD panel of the present invention have the following advantages.

(1) As the first and second switching elements are respectively disposed between two adjacent scan bonding pads and between adjacent data bonding pads, the static charge triggers the charge coupling effect of the first switching element and/or the second switching element, thereby turning on the first switching element and/or the second switching element. As such, the static charge has a less likelihood of being locally accumulated on the scan bonding pads and the data bonding pads, thereby lowering damage caused by the static charge.

(2) In a limited space, the source and the drain of the first and second switching elements are asymmetrically disposed, and when the static charge is accumulated on the scan bonding pads or the data bonding pads, the first and second switching elements are quickly turned on to allow the static charge to transport to neighbor scan lines or data lines.

(3) The transportation of the static charge can be conducted two ways by using two first switching elements connected in parallel or two second switching elements connected in parallel.

(4) The first and second switching elements are formed by using the conventional five-mask process without an extra process.

(5) The TFT array substrate with an anti-static guard capability is implemented into the LCD panel so that the LCD panel performs better because the damage caused by the static charge is abated.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A thin film transistor array substrate, comprising:
a substrate comprised of a display region and a peripheral circuit region;
a plurality of scan lines and data lines disposed on the substrate, dividing the display region into a plurality of pixel areas;
a plurality of pixel units respectively disposed in one of the pixel areas and driven by the scan lines and the data lines;
a plurality of scan bonding pads disposed in the peripheral circuit region and electrically connected to the scan lines;
a plurality of data bonding pads disposed in the peripheral circuit region and electrically connected to the data lines;
a plurality of first switching elements, disposed in the peripheral circuit region, wherein at least one of the first witching elements is disposed between two adjacent scan bonding pads and is electrically connected to the two scan bonding pads; and
a plurality of second switching elements disposed in the peripheral circuit region, wherein at least one of the second switching element is disposed between two adjacent data bonding pads, and is electrically connected to the two data bonding pads.

2. The thin film transistor array substrate of claim 1, wherein between two adjacent scan bonding pads are disposed two first switching elements.

3. The thin film transistor array substrate of claim 2, wherein the two first switching elements are connected in parallel.

4. The thin film transistor array substrate of claim 1, wherein between two adjacent data bonding pads are disposed two second switching elements.

5. The thin film transistor array substrate of claim 4, wherein the two second switching elements are connected in parallel.

6. The thin film transistor array substrate of claim 1, wherein each first switching element comprises:
a floating gate disposed on the substrate;
a gate insulating layer covering the floating gate;
a semiconductor layer disposed on the gate insulating layer over the floating gate; and
a source and a drain disposed on the semiconductor layer, wherein the source and the drain are electrically connected to the scan bonding pads disposed at two sides thereof.

7. The thin film transistor array substrate of claim 6, wherein the source and the drain are asymmetrically disposed.

8. The thin film transistor array substrate of claim 6, wherein the source and the drain are symmetrically disposed.

9. The thin film transistor array substrate of claim 1, wherein each second switching element comprises:
a floating gate disposed on the substrate;
a gate insulating layer covering the floating gate;
a semiconductor layer disposed on the gate insulating layer over the floating gate; and
a source and a drain disposed on the semiconductor layer, wherein the source and the drain are electrically connected to the data bonding pads disposed at two sides thereof.

10. The thin film transistor array substrate of claim 9, wherein the source and the drain are asymmetrically disposed.

11. The thin film transistor array substrate of claim 9, wherein the source and the drain are symmetrically disposed.

12. The thin film transistor array substrate of claim 1, wherein each pixel unit comprises a thin film transistor disposed in one of the pixel areas; and
a pixel electrode disposed in each pixel area and electrically connected to the thin film transistor.

13. The thin film transistor array substrate of claim 1, further comprises a plurality of inner guard rings which are disposed in the peripheral circuit region and are electrically connected to the scan lines and data lines between the scan bonding pads and the display region and between the data bonding pads and the display region.

14. The thin film transistor array substrate of claim 1, further comprises a plurality of external guard rings which are disposed in the peripheral circuit region and are electrically connected to the scan lines and data lines between the scan bonding pads and the outside of the substrate and between the data bonding pads and the outside of the substrate.

15. A liquid display panel, comprising:
a color filter substrate;
a thin film transistor array substrate, comprising a substrate comprised of a display region and a peripheral circuit region; a plurality of scan lines and data lines disposed on the substrate dividing the display region into a plurality of pixel areas; a plurality of pixel units respectively disposed in one of the pixel areas and driven by the scan lines and the data lines; a plurality of scan bonding pads disposed in the peripheral circuit region and electrically connected to the scan lines; a plurality of data bonding pads disposed in the peripheral circuit region and electrically connected to the data lines; a plurality of first switching elements disposed in the peripheral circuit region, wherein at least one of the first witching elements is disposed between two adjacent scan bonding pads and is electrically connected to these two the scan bonding pads; and a plurality of second switching elements disposed in the peripheral circuit region, wherein at least one of the second switching element is disposed between two adjacent data bonding pads, and is electrically connected to these two data bonding pads; and
a liquid crystal layer disposed between the color filter substrate and the thin film transistor array substrate.
